(19) United States
(12) Patent Application Publication
(10) Pub. No.: US 2008/0026735 A1
(43) Pub. Date: Jan. 31, 2008

(54) APPARATUS AND METHOD FOR TRANSMITTING AND RECEIVING POSITION INFORMATION IN PORTABLE TERMINAL

(75) Inventor: Sung-Hwan LEE, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/829,591

(22) Filed: Jul. 27, 2007

(30) Foreign Application Priority Data
Jul. 31, 2006 (KR) 2006-0071936

(51) Int. Cl. H04Q 7/22

(52) U.S. Cl. 455/414.3

(57) ABSTRACT

A portable terminal and a method for transmitting position information of a portable terminal. are provided, which includes identifying the position information, upon identifying the position information. constructing the position information into a Dual Tone Multi Frequency (DTMF) signal. and transmitting the DTMF signal via the voice call channel. As a result, the portable terminal is able to transmit and receive the position information via the voice call channel. without having to use a separate communication network provided by a position information service provider.

### PRIORITY

This application claims priority under 35 U.S.C. § 119 to an application filed in the Korean Intellectual Property Office oil Jul. 31, 2006 and assigned Serial No. 2006-71936, the contents of which are incorporated herein by reference.

### BACKGROUND OF THE INVENTION

1. Field of the Invention

The present invention relates to an apparatus and a method for transmitting and receiving position information being received from a GPS satellite in a portable terminal having a Global Positioning System (GPS). and more particularly, to an apparatus and a method for transmitting and receiving the position information via a voice call channel in a portable terminal.

2. Description of the Related Art

Portable terminals have now become almost a necessity for people, and have rapidly been distributed in society due to their convenience and practicality. Service providers, including manufacturers of the terminals, try to provide additional functions to improve the utilization of the portable terminals. The additional functions include a phone book, games, a scheduler, Short Message Service (SMS), Multimedia Message Service (MMS), Internet service, e-mail, location based service, MPEG Layer 3 (MP3), a digital camera, etc.

Among these, the location based service locates the portable terminal, using the GPS technology. The portable terminal is equipped with a GPS receiver to receive position information from the GPS satellite and inform a counterpart terminal of the position information.

FIG. 1 schematically illustrates a conventional system to transmit and receive position information.

Referring to FIG. 1, a terminal A 110 and a terminal B 120 are on voice call communication with each other, via a base station A 130. Terminal A 110 is equipped with a GPS receiver and thus is able to receive position information from the GPS satellite 140.

Terminal B 120 sends a request to Terminal A 110 for position information. The request for position information is transmitted to terminal A 110 over a separate GPS communication provider network 150. The GPS communication provider network 150 is Transmission Control Protocol/Internet Protocol (TCP/IP) based network, and includes a control server and a control client.

Terminal A 110, in response to the request for position information, receives position information from the GPS satellite 140, and provides terminal B 120 with the received position information over the GPS communication provider network 150.

As explained above, when a portable terminal needs to provide the location based service using GPS, although the portable terminal is already connected with a counterpart terminal requesting the position information via a voice call channel, the portable terminal has to use a separate network provided by the GPS communication provider to transmit the position information.

### SUMMARY OF THE INVENTION

An aspect of the present invention is to substantially solve at least the above problems and/or disadvantages and to provide at least the advantages below. Accordingly, an aspect of the present invention is to provide an apparatus and a method for transmitting and receiving position information via a voice call channel in a portable terminal.

Another aspect of the present invention is to provide an apparatus and a method for transmitting and receiving position information with a Dual Tone Multi Frequency (DTMF) signal in a portable terminal.

The above aspects are achieved by providing an apparatus and method for transmitting and receiving position information in a portable terminal.

According to an aspect of the present invention, there is provided a method of transmitting position information in a portable terminal. The method includes identifying the position information, upon identifying the position information, constructing the position information into a Dual Tone Multi Frequency (DTMF) signal, and transmitting the DTMF signal via a voice call channel.

According to another aspect of the present invention, there is provided a method of receiving position information in a portable terminal. The method includes upon receiving a Dual Tone Multi Frequency (DTMF) signal, identifying the position information, based on the data structure of the DTMF signal, and upon identifying the position information, converting the DTMF signal into the position information.

According to a further aspect of the present invention, there is provided a portable terminal, which includes a Global Positioning System (GPS) receiver for receiving position information from a GPS satellite, a Dual Tone Multi Frequency (DTMF) converting unit for converting the position information into a DTMF signal, and a communication unit for transmitting the DTMF signal.

According to a further aspect of the present invention, there is provided a portable terminal, which includes a Dual Tone Multi Frequency (DTMF) sequence identifying unit for identifying position information in a received DTMF signal, a DTMF converting unit for extracting the position information from the DTMF signal, and a communication unit for receiving the DTMF signal.

### BRIEF DESCRIPTION OF THE DRAWINGS

The above and other objects, features and advantages of the present invention will become more apparent from the following detailed description when taken in conjunction with the accompanying drawings in which:

FIG. 1 schematically illustrates a conventional system for transmitting and receiving position information;

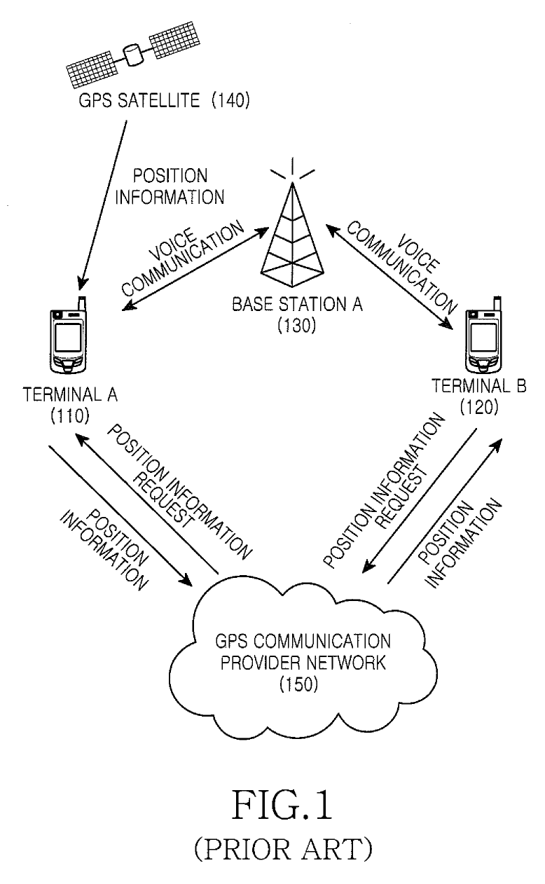

FIG. 2 is a block diagram of a portable terminal according to the present invention;

FIG. 3 is a flowchart of the process of transmitting position information via a voice call channel in a portable terminal according to the present invention;

FIG. 4 is a flowchart of the process of receiving position information via a voice call channel in a portable terminal according to the present invention; and

FIG. 5 illustrates the structure of a position information signal according to the present invention.

### DETAILED DESCRIPTION OF THE PREFERRED EMBODIMENTS

Preferred embodiments of the present invention will be described herein below with reference to the accompanying drawings. In the following description. well-known functions or constructions are not described in detail since they would obscure the invention in unnecessary detail.

An apparatus and a method for transmitting and receiving position information via a voice call channel in a portable terminal according to the present invention will be explained below. In the following description, an implementation is particularly explained, in which the Global Positioning System (GPS) is employed to transmit the position information.

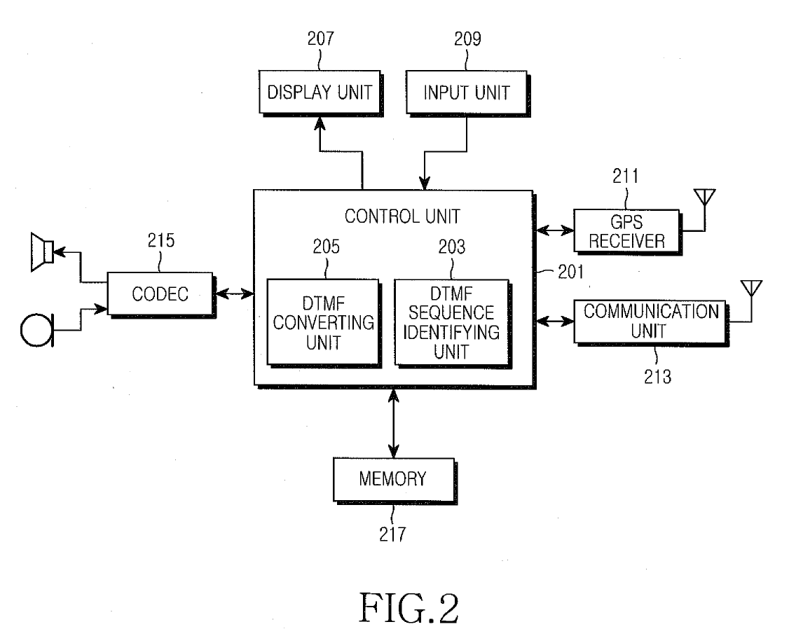

FIG. 2 is a block diagram of a portable terminal according to the present invention.

In the implementation explained below, the portable terminal may include a cellular phones a Personal Communication System (PCS), a Personal Data Assistant (PDA), and an International Mobile Telecommunication-2000 (IMT2000) terminal, each incorporating a GPS receiver therein. and the implementation will be explained with reference to the general constructions of these terminals.

Referring to FIG. 2, the portable terminal may include a control unit 201, a display unit 207, an input unit 209. a GPS receiver 211, a communication unit 213, a CODEC (COder-DECoder) 215, and a memory 217.

The control unit 201 controls the overall operation of the portable terminal. For example, the control unit 201 may handle processing and controlling of voice communication and data communication. According to the present invention, the control unit 201 may also control the transmitting and receiving of position information being provided by the GPS receiver 211, via a voice call channel.

The control unit 201 includes a DTMF sequence identifying unit 203, such that upon receiving a DTMF signal, the control unit 201 checks the data structure of the DTMF signal and determines whether the DTMF signal is position information. More specifically, the control unit 201 determines whether the received DTMF signal is position information, based on the determination whether the DTMF signal includes a starting sequence and ending sequence.

The control unit 201 may also include a DTMF converting unit 205 to convert the position information into a DTMF signal or vice versa. The control unit 201, upon determination that the position information is being transmitted, controls the processing such that the position information is converted into the DTMF signal according to an encoding scheme, and the starting sequence and the ending sequence are added to the DTMF signal. However, upon determination that the position information is being received, the control unit 201 controls the processing such that a DTMF signal determined to be the position information at the DTMF sequence identifying unit 203 is provided, the starting sequence and the ending sequence are removed from the DTMF signal, and the DTMF signal is converted into position information according to a decoding scheme.

The display unit 207 displays status information, numbers, text and images, as these are generated during the operation of the portable terminal. The input unit 209 includes a keypad of the portable terminal, and provides key input data to the control unit 201 according to the input by the user.

The GPS receiver 211 receives position information of the portable terminal from the GPS satellite. The communication unit 213 processes a Radio Frequency (RF) signal, such as a voice signal, or a DTMF signal, being transmitted and received over an antenna.

The CODEC 215 converts Pulse Code Modulation (PCM) data being provided from the control unit 201 into analog voice signals and outputs the converted signals through a speaker. The CODEC 215 converts the analog voice signals being input through a microphone into PCM data and outputs the converted data to the control unit 201.

The memory 217 stores programs to control the overall operation of the portable terminal, reference data. temporary data generated according to the executing of the programs, and other updateable necessary data.

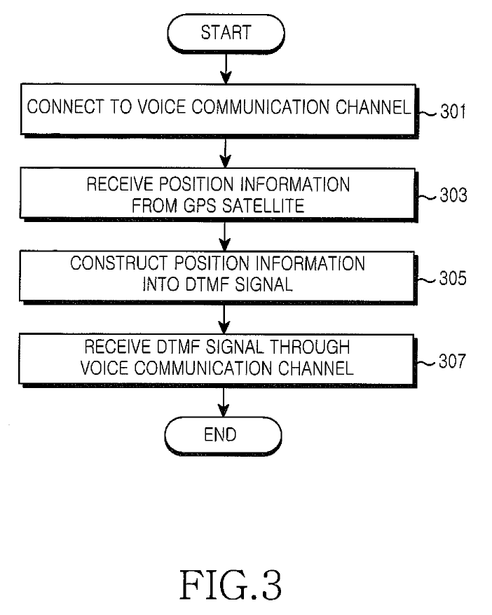

FIG. 3 illustrates the process of transmitting position information via a voice call channel in a portable terminal according to the present invention.

Referring to FIG. 3, the control unit 201 is connected with a voice call channel in step 301. In other words, the control unit 201 is already connected with a channel through which a DTMF signal can be transmitted and received.

The control unit 201 proceeds to step 303 to receive position information from the GPS satellite.

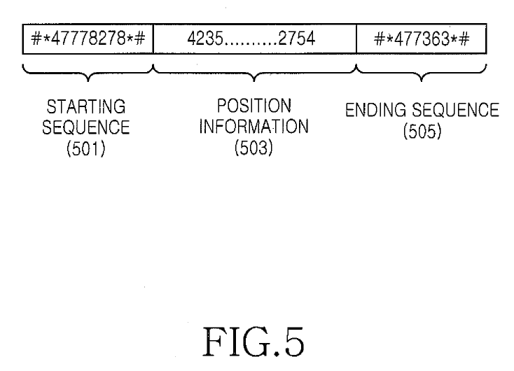

Upon receiving the position information, the control unit 201 proceeds to step 305 to constrict the received position information into a DTMF signal. That is, the position information is converted into a DTMF signal according to an encoding scheme, and the converted signal is added with a starting sequence and an ending sequence so that the counterpart terminal can recognize the signal as the position information. For example, referring to FIG. 5, the DTMF signal is constructed, including a starting sequence 501 (#*47778278*#), position information 503, and an ending sequence 505 (#*477363*#).

After constructing the DTMF signal, the control unit 201 proceeds to step 307 to transmit the DTMF signal via the voice call channel.

The control un it 201 then terminates the process.

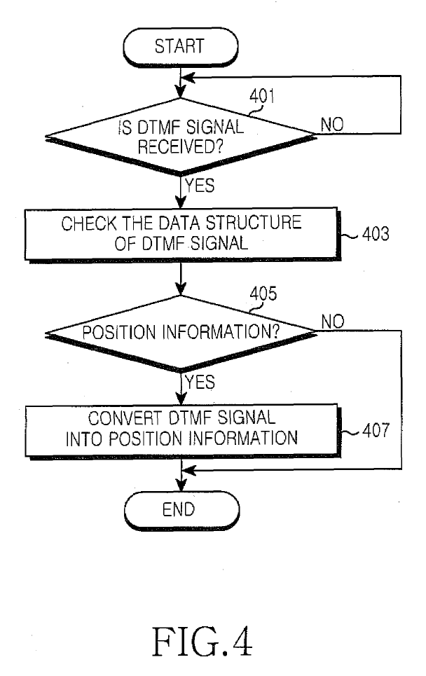

FIG. 4 illustrates the process of receiving the position information via the voice call channel in a portable terminal according to the present invention.

Referring to FIG. 4, the control unit 201 determines whether a DTMF signal is received via the voice call channel in step 401.

If the DTMF signal is received, the control unit 201 checks the structure of the DTMF signal in step 403. That is, the control unit 201 determines the data included in the received DTMF signal, and the order of the included data.

The control unit 201 then proceeds to step 405, to determine whether the DTMF signal is position information. That is, the control unit 201 determines whether a starting sequence and an ending sequence are included in the DTMF signal, referring to the determined data structure. For example, the control unit 201 may determine whether the starting sequence 501 and the ending sequence 505 as illustrated in FIG. 5 are included in the DTMF signal.

If the DTMF signal is position information, the control unit 201 proceeds to step 407 to convert the DTMF signal into position information. That is, the starting sequence and the ending sequence are removed from the DTMF signal, and the DTMF signal is converted into position information according to a decoding scheme.

The control unit 201 then terminates the process.

Exemplary implementations of a portable terminal transmitting and receiving position information via a voice call channel, which is already connected, have been explained so far. A system which is always connected with a voice call channel, such as a Push-to-Talk (PTT) system, may be a more desirable example to incorporate the inventive feature of the present invention because it does not require a channel connecting process.

As explained above, by constructing the position information with a DTMF signal, a portable terminal is able to transmit and receive the position information via the voice call channel, without using a communication network provided by a GPS service provider. The effect of the present invention will be particularly maximized in the implementations which are always connected with the voice call channel, such as a Push-to-Talk (PTT) system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for transmitting position information of a portable terminal. comprising:
identifying position information:
upon identifying the position information, constructing the position information into a Dual Tone Multi Frequency (DTMF) signal; and
transmitting the DTMF signal via a voice call channel.

2. The method of claim 1, wherein the position information is received from a Global Positioning System (GPS) satellite.

3. The method of claim 1, wherein constructing the position information into the DTMF signal comprises:
converting the position information into the DTMF signal according to an encoding scheme: and
adding a starting sequence and an ending sequence to the DTMF signal.

4. A method for receiving position information in a portable terminal, comprising:
upon receiving a Dual Tone Multi Frequency (DTMF) signal, identifying position information based on a data structure of the DTMF signal; and
upon identifying the position information converting the DTMF signal into the position information.

5. The method of claim 4, wherein identifying of the position information is based on a determination whether a starting sequence and an ending sequence are included in the DTMF signal.

6. The method of claim 4, wherein converting the DTMF signal into position information comprises:
removing a starting sequence and an ending sequence from the DTMF signal; and
converting the sequence-removed DTMF signal into position information according to a decoding scheme.

7. A portable terminal, comprising:
a Global Positioning System (GPS) receiver for receiving position information from a GPS satellite;
a Dual Tone Multi Frequency (DTMF) converting unit for converting the position information into a DTMF signal; and
a communication unit for transmitting the DTMF signal.

8. The portable terminal of claim 7, wherein the DTMF converting unit converts the position information into a DTMF signal according to an encoding scheme, and adds a starting sequence and an ending sequence the converted signal.

9. A portable terminal, comprising:
a Dual Tone Multi Frequency (DTMF) sequence identifying unit for identifying position information in a received DTMF signal;
a DTMF converting unit for extracting the position information from the DTMF signal; and
a communication unit for receiving the DTMF signal.

10. The portable terminal of claim 9, wherein the DTMF sequence identifying unit outputs the DTMF signal to the DTMF converting unit, if the received DTMF signal includes a starting sequence and an ending sequence.

11. The portable terminal of claim 9, wherein the DTMF converting unit removes a starting sequence and an ending sequence from the DTMF signal and converts the sequence-removed signal into position information according to a decoding scheme.

12. A method for transmitting position information of a portable terminal, comprising:
identifying position information;
constructing the position information into a Dual Tone Multi Frequency (DTMF) signal.

13. The method of claim 12, wherein the position information is received from a Global Positioning System (GPS) satellite.

14. The method of claim 12, wherein constructing the position information into the DTMF signal comprises:
converting the position information into the DTMF signal according to an encoding scheme: and
adding a starting sequence and an ending sequence to the DTMF signal.

15. A method for receiving position information in a portable terminal, comprising:
identifying position information based on a data structure of a Dual Tone Multi Frequency (DTMF) signal; and
converting the DTMF signal into the position information.

16. The method of claim 15, wherein identifying of the position information is based on a determination whether a starting sequence and an ending sequence are included in the DTMF signal.

17. The method of claim 15, wherein converting the DTMF signal into position information comprises:
removing a starting sequence and an ending sequence from the DTMF signal; and
converting the sequence-removed DTMF signal into position information according to a decoding scheme.

18. A portable terminal for transmitting position information comprising:
means for identifying position information:
means for constructing the position information into a Dual Tone Multi Frequency (DTMF) signal.

19. A portable terminal for receiving position information comprising:
means for identifying position information based on a data structure of a Dual Tone Multi Frequency (DTMF) signal: and
means for converting the DTMF signal into the position information.
